(19) United States
(12) Patent Application Publication
(10) Pub. No.: US 2010/0169333 A1
(43) Pub. Date: Jul. 1, 2010

(54) DOCUMENT PROCESSOR

(76) Inventor: Katsuhiro Matsuka, Tokushima-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/160,709

(22) PCT Filed: Jan. 15, 2007
(86) PCT No.: PCT/JP2007/050448

§ 371 Date: Jul. 11, 2008

(30) Foreign Application Priority Data
Jan. 13, 2006 (JP) 2006-006773

(51) Int. Cl. G06F 17/30; G06F 17/00

(52) U.S. Cl. 707/758; 715/234; 707/E17.014

(57) ABSTRACT

A technique to appropriately process structured data is provided. If a conditional expression related to data stored in a database system is included in a document processing apparatus, a query builder generates a query statement corresponding to the database system from the conditional expression. A database plug-in sends the generated query statement to the database system and then acquires a query result from the database system. A view builder generates a view for displaying the acquired query result. The document processing apparatus displays a display screen for a document including the generated view.

### FIELD OF THE INVENTION

The present invention relates to a data processing technique and particularly to a document processing apparatus for processing a document structured in a markup language and a data processing system in which the document processing apparatus can be used.

### DESCRIPTION OF THE RELATED ART

In recent years, a movement for standardizing various information, which companies deal with, using XML has progressed rapidly. W3C has established XML schemas to be the infrastructure for systems such as XHTML, SVC, SOAP, WSDL, RDF, and X-query, and at the same time, industry organizations and standard-setting organizations, in cooperation, promote the standardization of a XML schema for business data such as XBRL, ebXML, EDIXML, UBL, Open Office XML, and Government XML.

[Patent document 1] Japanese Laid-Open Publication No. 2001-290804

### DISCLOSURE OF THE INVENTION

### Problem to be Solved by the Invention

While the standardization and partitioning of the information are accelerated as mentioned above, there is a strong need for the development of an “application model” for efficiently converting this into a corporate value.

### Means for Solving the Problem

An aspect of the present invention relates to a document processing apparatus. The document processing apparatus is operative to process a document structured in a markup language and comprises: a query builder operative, when data retained in a database system is embedded in the document, to generate a query statement which corresponds to the database system; and a view builder operative, when the result of the query statement is acquired from the database system in a format of the data structured in the markup language, to generate a screen which displays the result.

The query builder may acquire and present the information that indicates the structure of the data structured in a markup language retained in the database system, receive the specification of the data to be embedded into the document from among the data presented, and generate a query statement for the received data.

The query builder may acquire a correspondence relation of the data of the same type among the data structured in a markup language from a management server retaining the correspondence relation, and present the correspondence relation identifiably when presenting the structure of the data structured in the markup language.

The query builder may be able to generate a query statement for acquiring in the format of the data structured in a markup language the data not structured in the markup language retained in the database system.

Another aspect of the present invention relates to a data processing system. The data processing system comprises: document processing apparatus operative to process a document structured in a markup language; and a database system operative to retain data available for the document, wherein the document processing apparatus comprises: the query builder operative, when data retained in the database system is embedded in the document, to generate a query statement which corresponds to the database system; and a view builder operative, when the result of the query statement is acquired from the database system in a format of the data structured in the markup language, to generate a view which displays the result.

The data processing system may further comprise a management server for managing the correspondence relation between the data retained in the database system. The data processing system may be a complex database system with a XML database and a relational database.

Another aspect of the present invention relates to a document processing method. The document processing method comprises: generating, when a document processing apparatus that processes a document structured in a markup language embeds in the document data retained in a database system, a query statement corresponding to the database system; and generating, when the result of the query statement is acquired in the format of the data structured in the markup language from the database system, a screen for displaying the result.

Optional combinations of the aforementioned constituting elements, and implementations of the invention in the form of methods, apparatuses, and systems may also be practiced as additional modes of the present invention.

### Effect of the Invention

The present invention provides a technique for appropriately processing structured data.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows a configuration of a document processing apparatus according to the base technology;

FIG. 2 is a diagram which shows an example of an XML document which is a processing target;

FIG. 3 is a diagram which shows an example in which the XML document shown in FIG. 2 is mapped to a table described in HTML;

FIG. 4A is a diagram which shows an example of a definition file used for mapping the XML document shown in FIG. 2 to the table shown in FIG. 3;

FIG. 4B is a diagram which shows an example of a definition file used for mapping the XML document shown in FIG. 2 to the table shown in FIG. 3;

FIG. 5 is a diagram which shows an example of a screen on which the XML document, which has been described in a marks managing vocabulary and which is shown in FIG. 2, is displayed after having been mapped to HTML according to the correspondence shown in FIG. 3;

FIG. 6 is a diagram which shows an example of a graphical user interface provided by a definition file creating unit, which allows the user to create a definition file;

FIG. 7 is a diagram which shows another example of a screen layout created by the definition file creating unit;

FIG. 8 is a diagram which shows an example of an editing screen for an XML document, as provided by the document processing apparatus;

FIG. 9 is a diagram which shows another example of an XML document which is to be edited by the document processing apparatus;

FIG. 10 is a diagram which shows an example of a screen on which the document shown in FIG. 9 is displayed;

FIG. 11 is a schematic diagram which illustrates a process of creating a definition file according to the embodiment;

FIG. 12 is a diagram which shows a schema file according to the exemplary embodiment;

FIG. 13 is a diagram which shows a source file which corresponds to the schema file in FIG. 12;

FIG. 14 is a diagram which shows a definition file created based on the schema file in FIG. 12 and the source file in FIG. 13;

FIG. 15 is a diagram which shows an editing screen for a binding file;

FIG. 16 is a diagram which shows an editing screen for a layout file based on the editing result of the binding file in FIG. 15;

FIG. 17 is a screen view when the destination file based on the edit result in FIG. 16 is displayed;

FIG. 18 is a diagram which shows another example of an editing screen for a binding file;

FIG. 19 is a diagram which shows an editing screen for a layout file based on the editing result of the binding file in FIG. 17;

FIG. 20 is a screen view when the destination file based on the edit result in FIG. 18 is displayed;

FIG. 21 is a diagram which further shows another example of an editing screen for a binding file;

FIG. 22 is a diagram which shows an editing screen for a layout file based on the editing result of the binding file in FIG. 21;

FIG. 23 is a screen view when the destination file based on the edit result in FIG. 22 is displayed;

FIG. 24 is a diagram which further shows another example of an editing screen for a binding file;

FIG. 25 is a diagram which shows an editing screen for a layout file based on the editing result of the binding file in FIG. 24;

FIG. 26 is a screen view when the destination file based on the edit result in FIG. 25 is displayed;

FIG. 27 is a schematic diagram which further illustrates a process of creating a definition file;

FIG. 28 is a diagram which shows the configuration of a data processing system according to the embodiment;

FIG. 29 is a diagram which shows the creation process of a XMLDB integrated document application; and

FIG. 30 is a diagram which shows the process of using a XMLDB integrated document application.

### REFERENCE NUMERALS

20 document processing apparatus

22 main control unit

24 editing unit

30 DOM unit

32 DOM provider

34 DOM builder

36 DOM writer

40 CSS unit

42 CSS parser

44 CSS provider

46 rendering unit

50 HTML unit

52, 62 control unit

54, 64 editing unit

56, 66 display unit

60 SVG unit

70 database system

72 view builder

74 query builder

76 database plug-in

78 vocabulary management server

80 VC unit

82 mapping unit

84 definition file acquisition unit

86 definition file creating unit.

### BEST MODE FOR CARRYING OUT THE INVENTION

### (Base Technology)

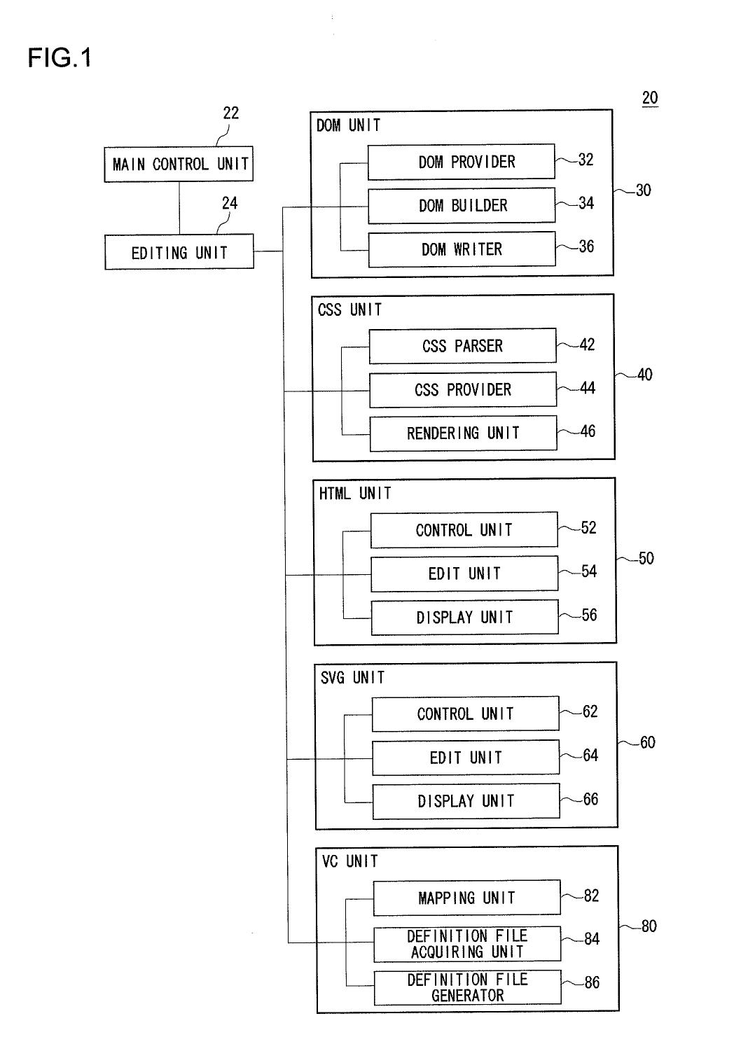

FIG. 1 illustrates a structure of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. These configurations are implemented in hardware component by any CPU of a computer, a memory or a program loaded into the memory. Functional blocks are implemented by the cooperation of hardware components. Thus, a person skilled in the art should appreciate that there are many ways of accomplishing these functional blocks in various forms in accordance with the components of hardware only, software only, or the combination of both.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the definition file does not exist, a source or tree structure of a document is displayed and the editing is carried out on the display screen.

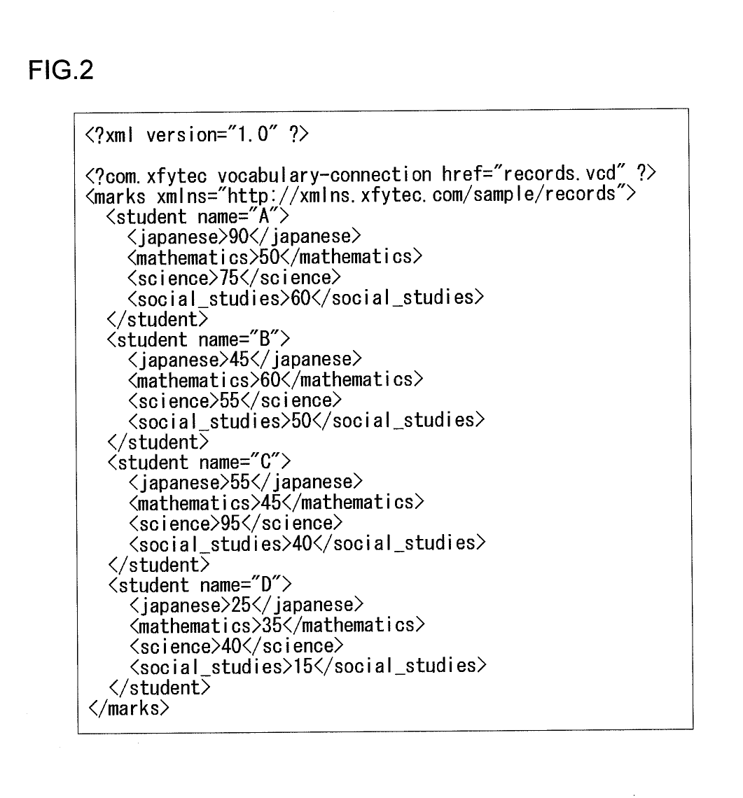

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social studies”. The attribute “name” stores the name of a student. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

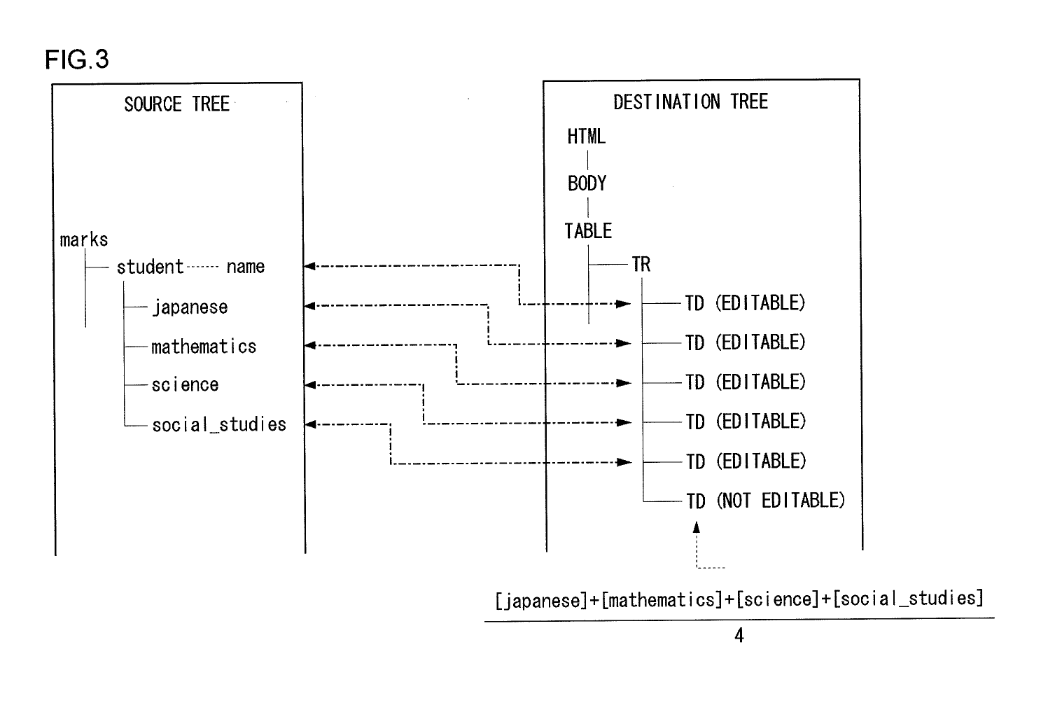

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

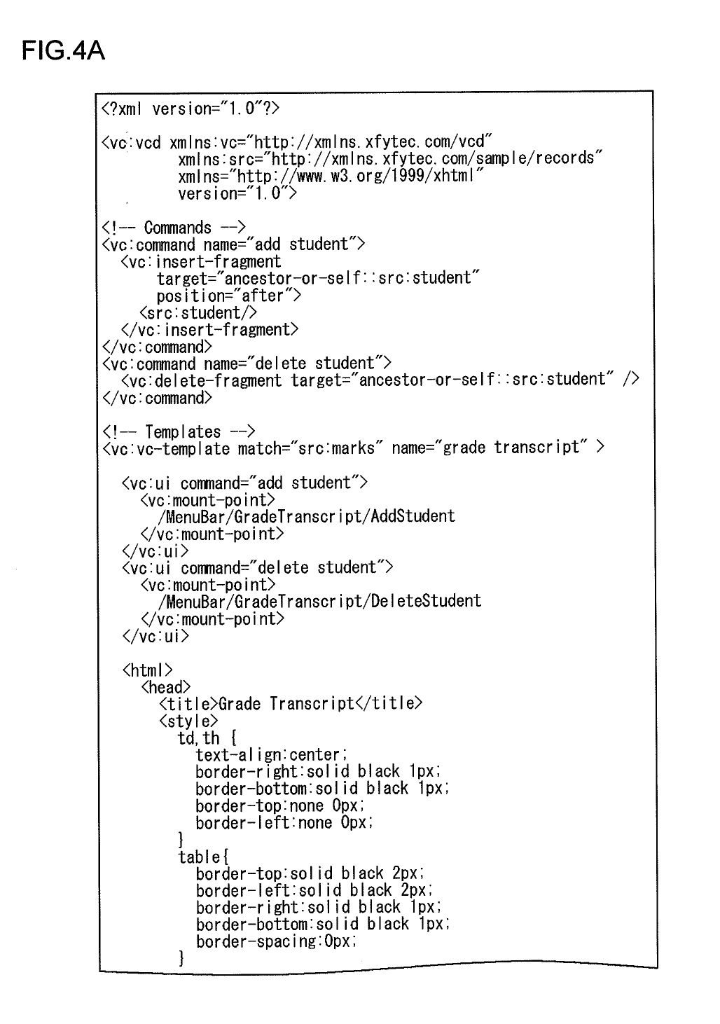

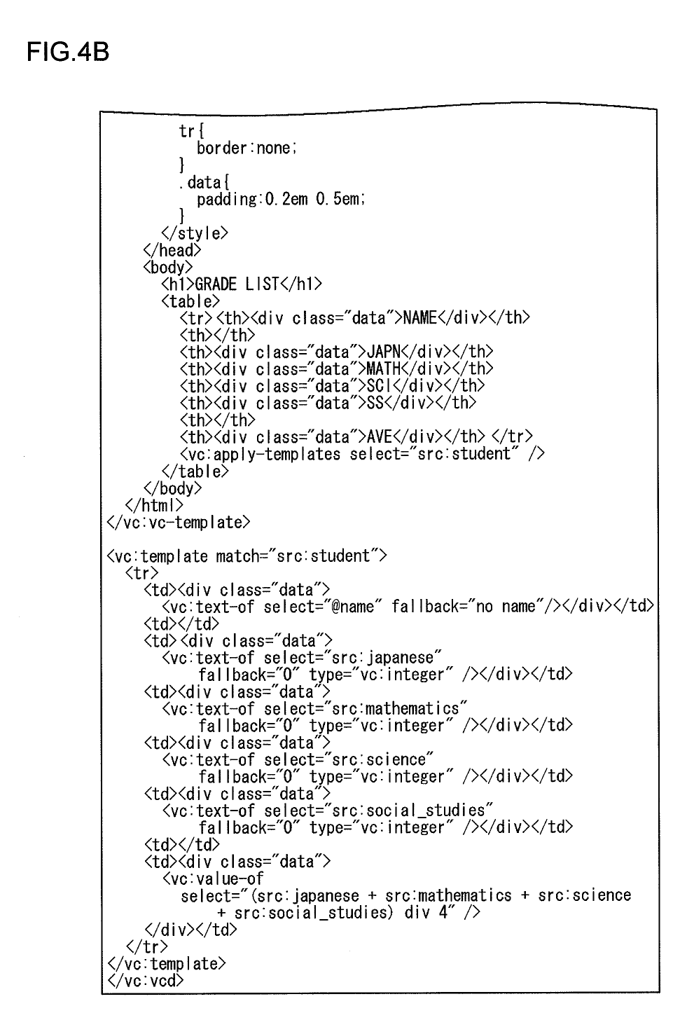

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src:japanese+src:mathematics+scr:science+scr:social studies) div 4” is described in the sixth row.

This means that the average of the student's marks is displayed.

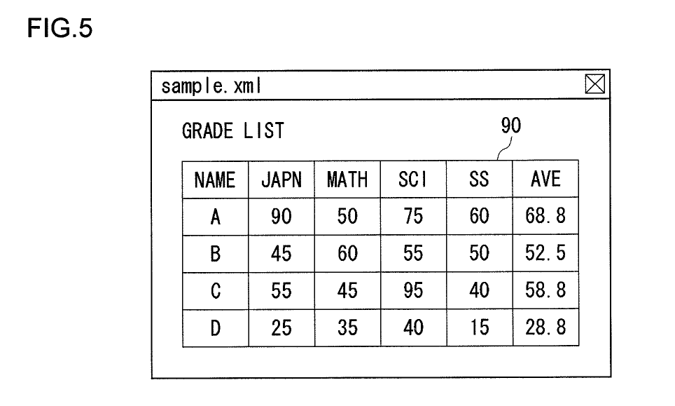

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

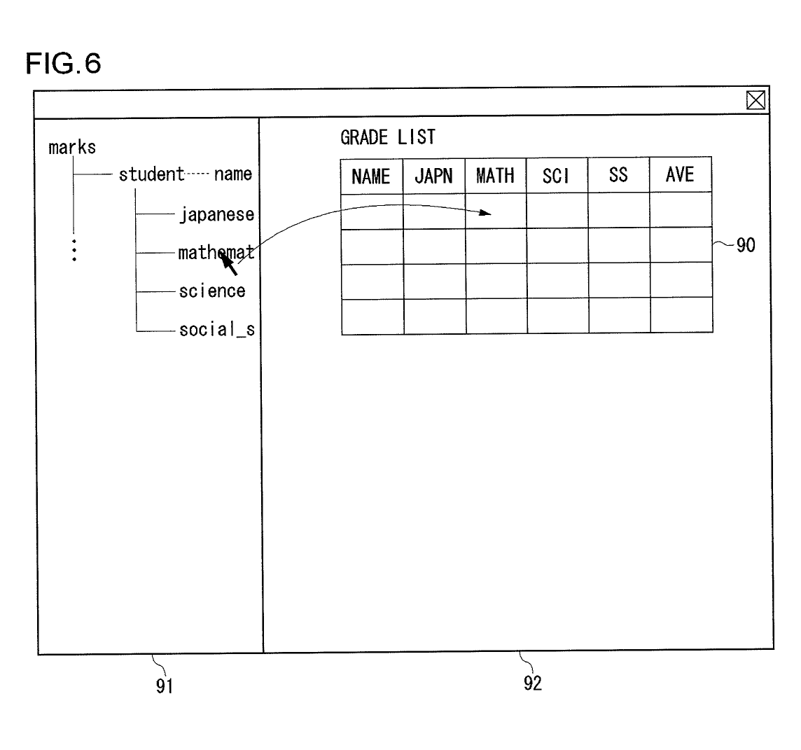

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

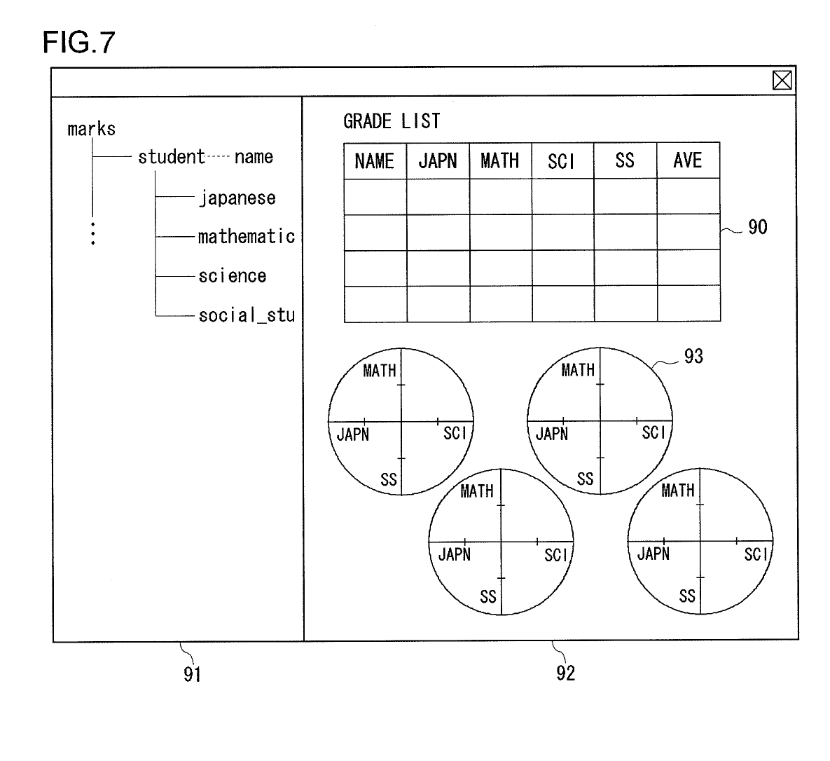

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

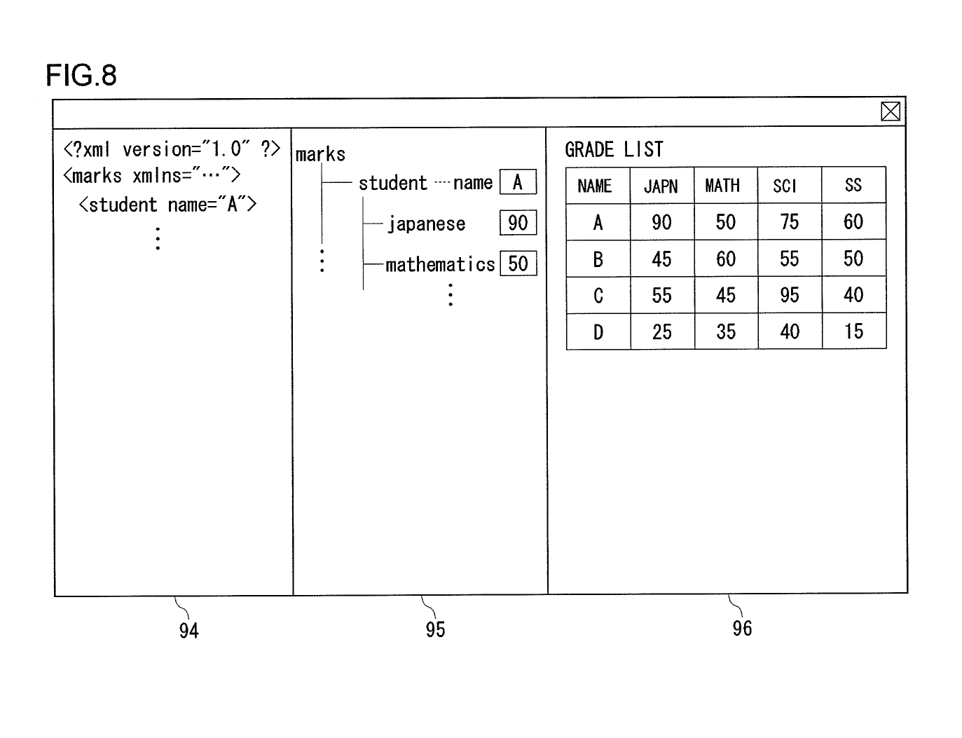

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

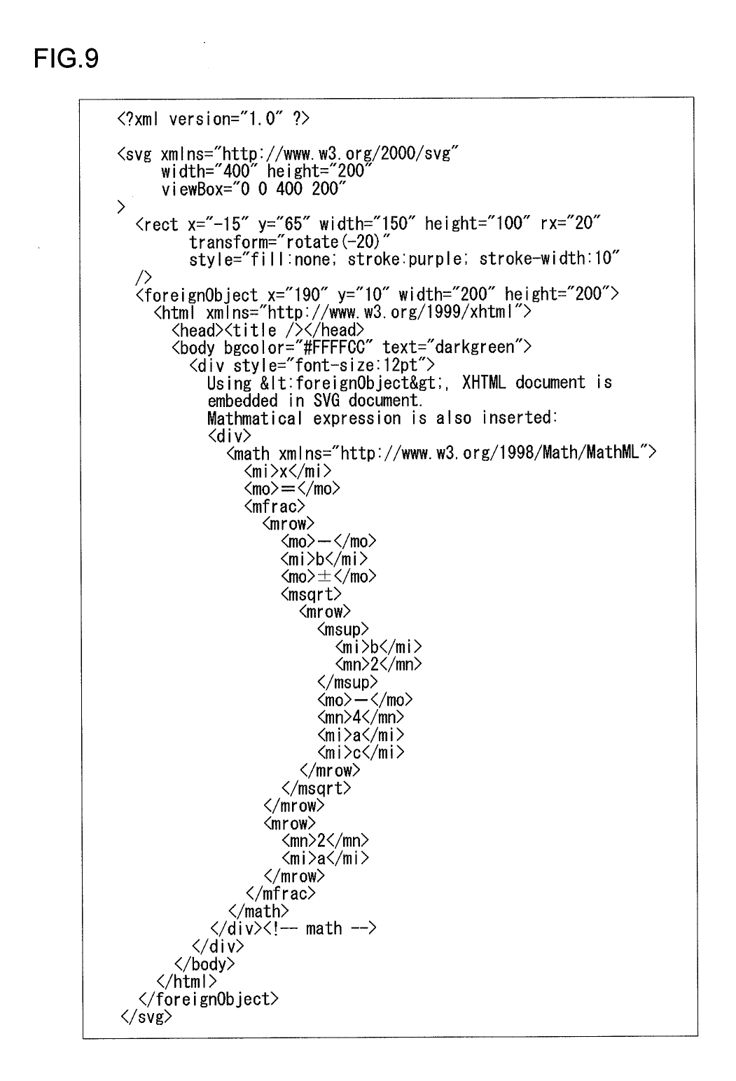

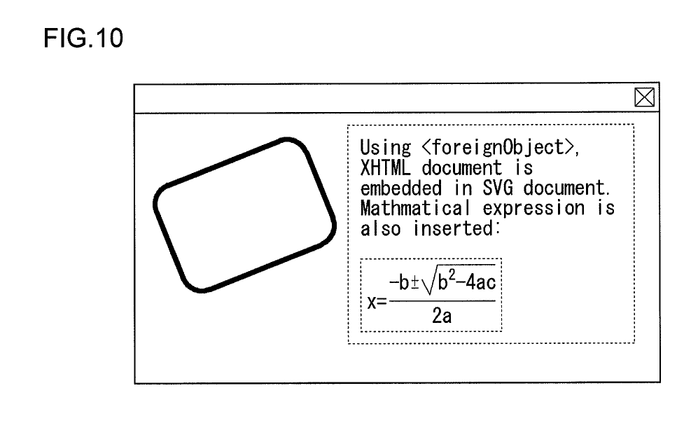

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

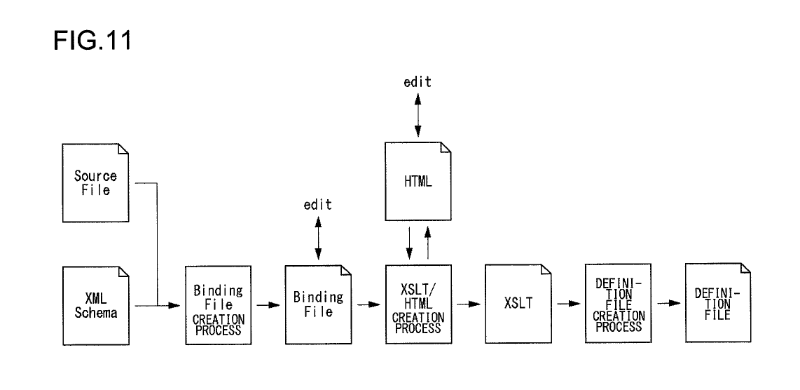

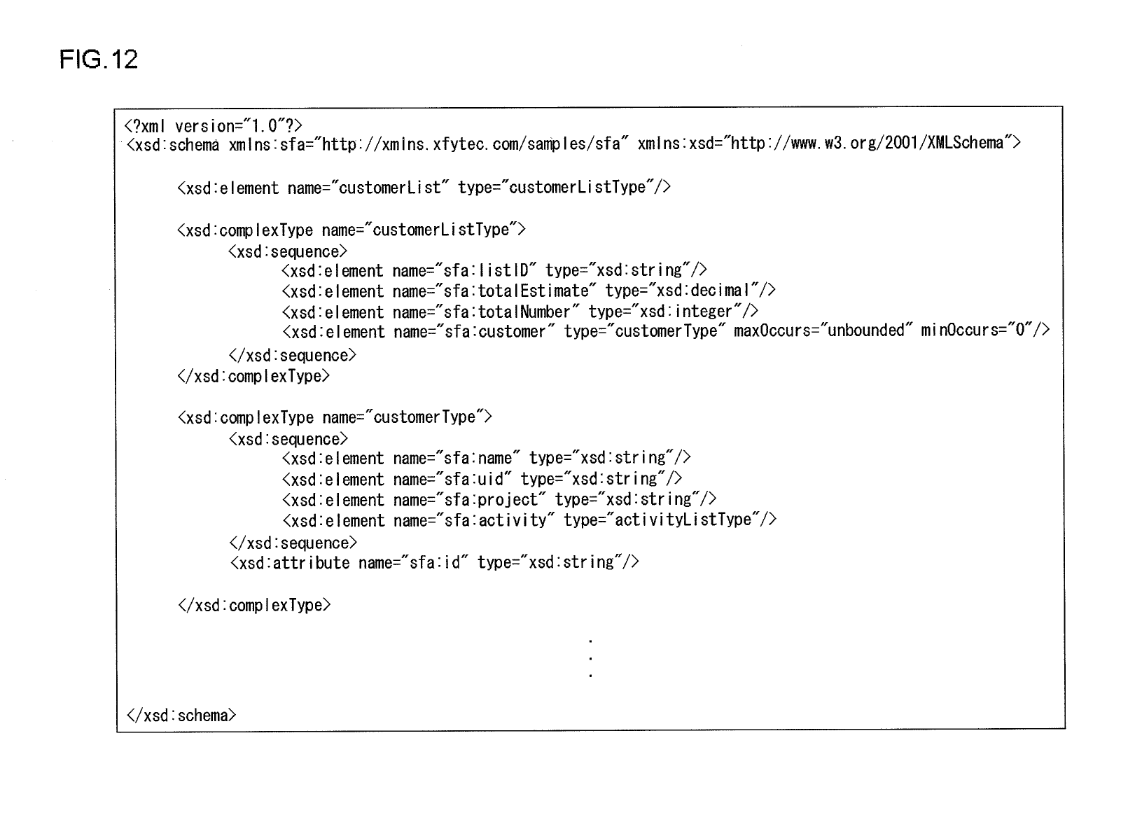

The function of automatically creating a screen that displays the data acquired from the database system is described in detail in the embodiment described hereinafter. A data processing apparatus that will be explained automatically creates a definition file for displaying the data and creates the screen that displays the data. Following the overview of the process of creating a definition file according to the embodiment in FIG. 11, a detailed description will be made mainly regarding the display mode in FIG. 12 and subsequent figures.

FIG. 11 is a schematic diagram which illustrates a process of creating a definition file according to the embodiment.

The data processing apparatus acquires an XML document file which is subject to be edited (hereinafter referred to as “source file”) and a schema file which defines the element structure of the source file. The schema file referred here is described according to the features, for example, XML-Schema and DTD (Document Type Definition). The definition file as a product is a file to create the destination file having the display layout information appropriate for editing the source file. The destination file can be assumed to be the filed destination tree, the destination tree which is described in the base technology.

In the presence of a schema file, the data processing apparatus creates a binding file from the schema file. The binding file is used for editing the display layout in the destination file. In the absence of the schema file, the data processing apparatus creates a binding file by extracting the element and its structure from the source file. In this case, the data processing apparatus extracts the element and its structure by extracting a child element from a root element of the source file using a tree traverse method.

Furthermore, the rule on the element of the source file can be redefined by the binding file. For example, an element A in the source file supposedly has four child elements B when the binding file is created from the source file. In this case, the rule is listed in the binding file, stating that the number of the child elements B which the element A can have is up to four. A user can redefine the rule on the element A and the child element B via the method provided by the binding file. For example, the number of the child element B which the element A can have may be defined from 1 to 10. Even when the binding file is created form the schema file, the rule on such elements may be redefined within the rules defined in the schema file.

As stated above, the binding file provides the rule on the elements and the function to define the rule.

The following description is made under the condition where the schema information which shows the element structure of the source file is acquired from the schema file.

A user can edit the binding file in the data processing apparatus. The user can set the basic display layout of the destination file in the binding file by GUI (Graphical User Interface). With this, a layout file is created by applying the display layout information defined in the binding file to each element of the schema information. The layout file is a HTML file which shows a specific display layout of each element included in the schema file. The layout file is not limited to a structured document file, a type of file which is structured by tags, and may be a file which includes the display layout information such as a spreadsheet application and an application for the presentation. The user can edit the display layout further elaborately by editing the layout file itself. In this embodiment, the basic setting of the display layout of the destination file is performed using the binding file; and the advanced setting of the display layout is performed using the layout file.

An XSLT file is created so that the data interchange format between the source file and the destination file is set by the correspondence relation of the element shown in the binding file and the display area of the layout file. Finally, a definition file is created showing the correspondence relation of the source file corresponding to the binding file and the destination file corresponding to the layout file based on the XSLT file.

A description will now be given of a flow of these processes, focusing on the user interface.

FIG. 12 is a diagram which shows a schema file according to the exemplary embodiment.

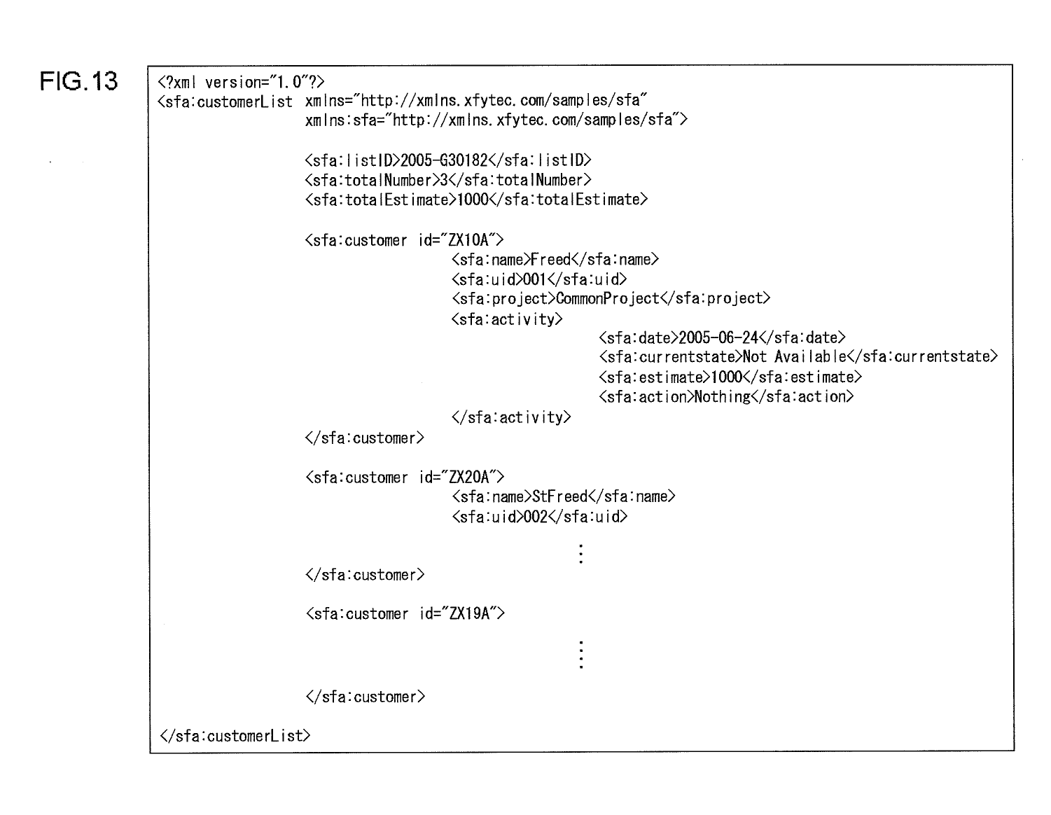

The schema file shown in the figure lists the rules on the element structure to which the source file shown in the following FIG. 13 needs to follow. Also, this schema file is described by following the feature called XML-Schema.

For example, in FIG. 31, the data type of the element, which is in the third row from the top, named “customerList” is defined as “customerListType”. In the following row, the data type “customerListType” is defined to have four child elements, “listID”, “totalEstimate”, “totalNumber”, and “customer” in the respective namespaces. Furthermore, the data type of “customer” is “customerType” and its contents is also defined. Also, the number of the element “customer” is defined to be at least 0.

The source file must be described according to the rules shown in the schema file. Since the schema file is a file which rules the data type and the structure of the each element included in the source file, the rules on the structure among the elements are more comprehensible than the source file itself.

FIG. 13 is a diagram which shows a source file which corresponds to the schema file in FIG. 12.

In this source file, the elements “listID”, “totalNumber”, “totalEstimate”, and “customer” are defined as child elements of the “customerList”. Also, these elements contain values. Three “customer” elements are contained.

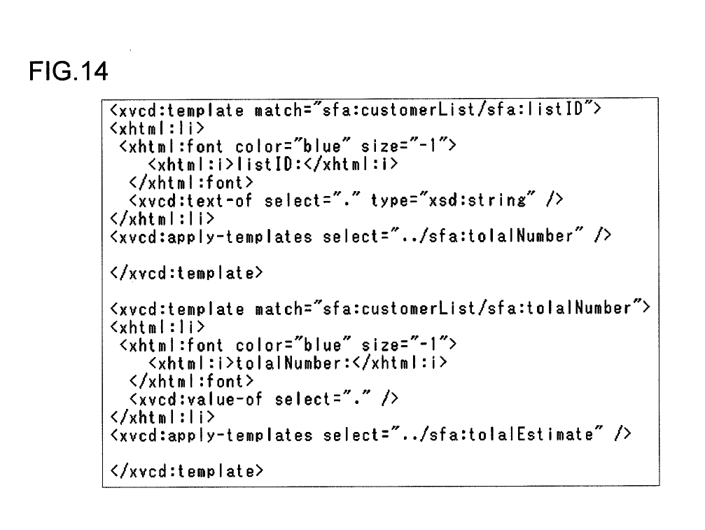

FIG. 14 is a diagram which shows a definition file created based on the schema file in FIG. 12 and the source file in FIG. 13.

FIG. 14 shows a part of the definition file. In the definition file shown in the figure, the rules are described for conversion of each element of the source file (e.g., “sfa:customerList/sfa:listID” and “sfa:customerList/sfa:totalNumber”) to the destination file in XHTML format. The data processing apparatus according to the exemplary embodiment can easily create the definition file in the intuitive user interface.

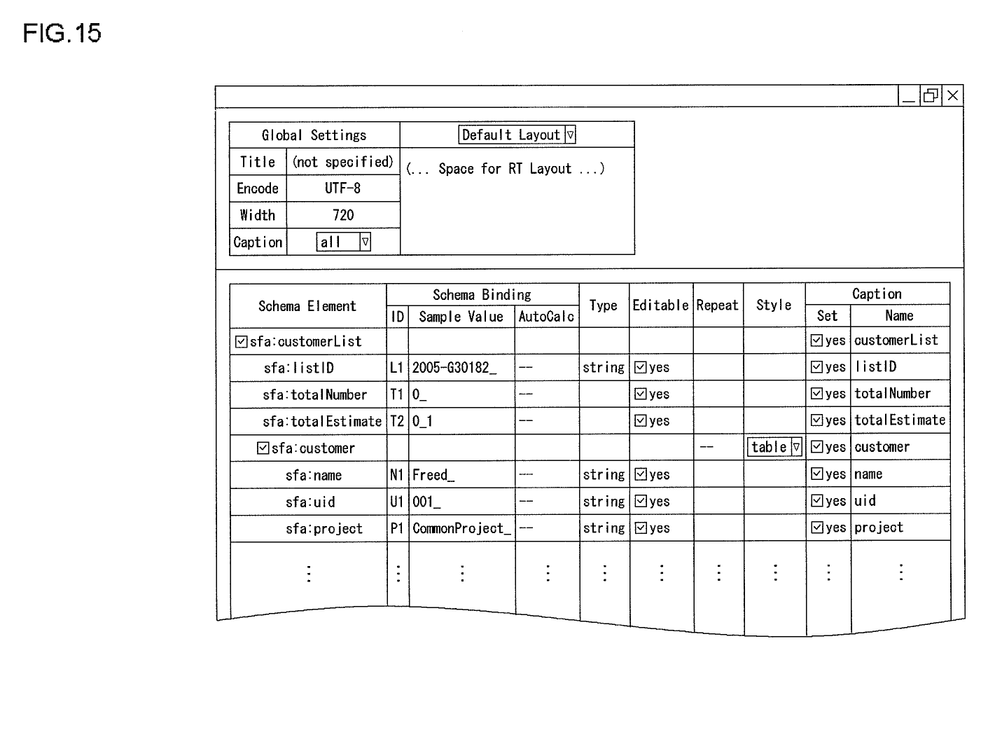

FIG. 15 is a diagram which shows an editing screen for a binding file.

The data processing apparatus displays the binding file created from the schema file as an image in a predetermined format shown in FIG. 15. In the bottom area of the FIG. 34 (hereinafter referred to as “property area”), each element shown in the schema file is displayed in tree view and, for example, its data type, is also displayed in editable format. In the property area, the child elements can be displayed in expanded view by checking a check box next to the element name. According to this aspect, even if vast numbers of elements are defined in the schema file, only the elements subject to be edited can be displayed.

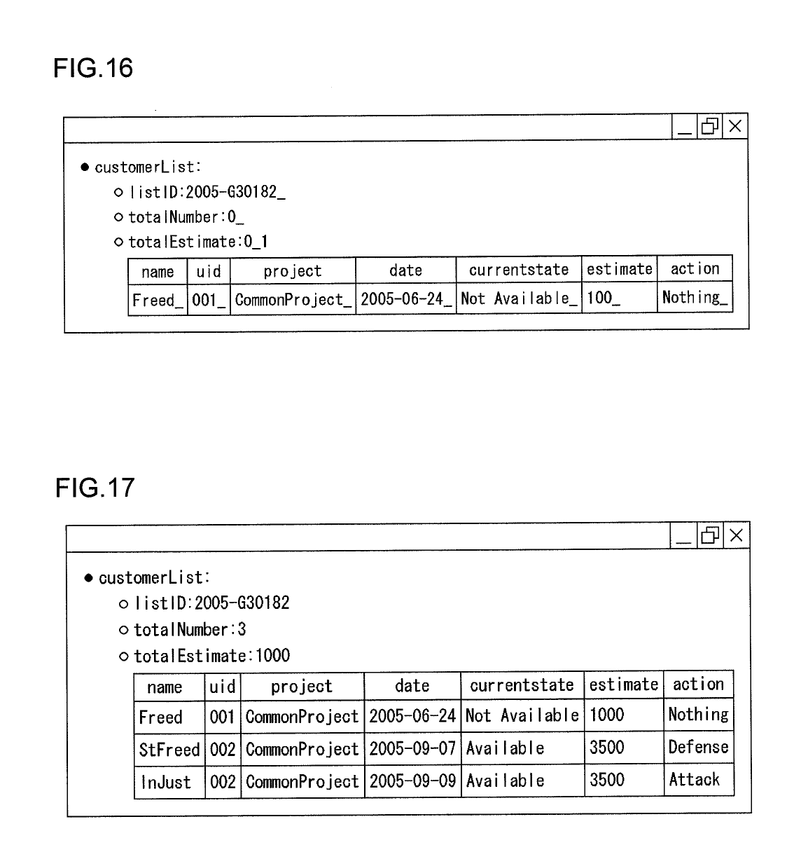

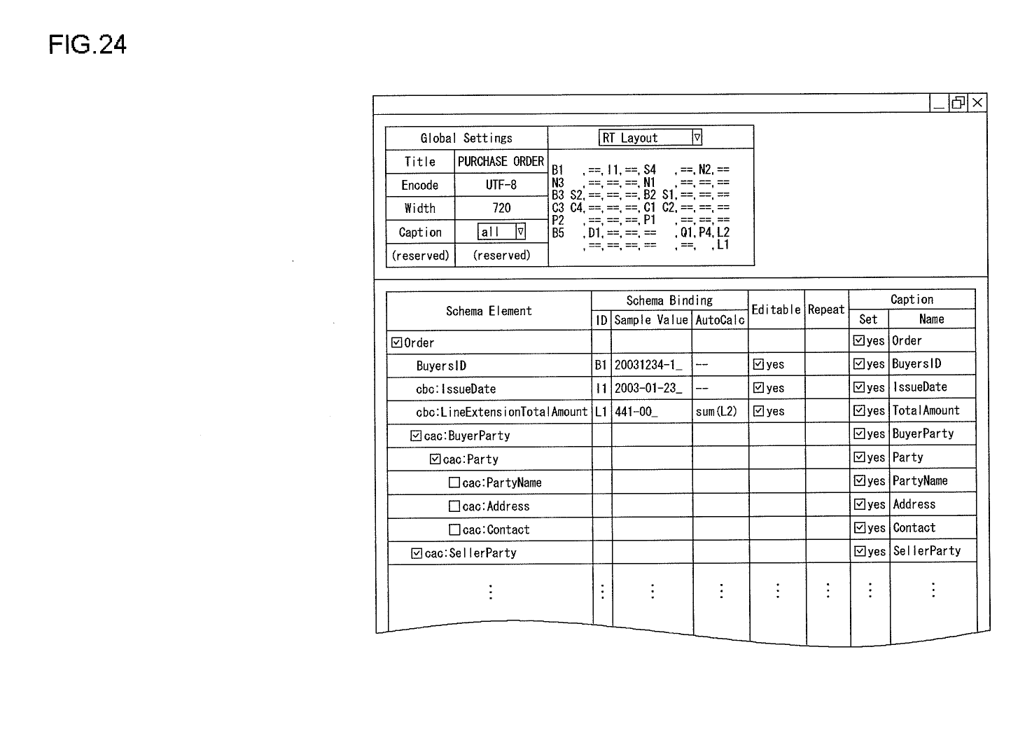

The data processing apparatus set a unique ID to each element. For example, an ID called “L1” is set for the element “listID”. The ID is determined by combining the initial letter of the element “L” and the serial number “1”. Also, the data processing apparatus set a unique sample value to each element. A sample value “2005-G30182” is set to the element “listID”. In the upper part of the center of FIG. 34, the area (hereinafter referred to as “layout area”) is set to define the display format of these elements. The user can reflect the change in the layout file by arranging the ID of each element in the layout area. The relation between the layout area and the layout file will be explained in relation to FIG. 24 or after. In the middle row of the property area in FIG. 15, the display format is assigned so that the element “customer” is displayed in table format. This assignment is reflected in the layout file shown in the following FIG. 16.

FIG. 16 is a diagram which shows an editing screen for a layout file based on the editing result of the binding file in FIG. 15.

The child element of the element “customer” is displayed in table format according to the assignment in FIG. 15. For example, the element “customerList/customer/name” of the schema file corresponds to the most left display area of the table shown in the layout file. The setting in the layout area in FIG. 15 is reflected in the display format. The user can edit the layout file in so-called WYSIWYG (What You See Is What You Get) in this edit display.

Thus, the display layout of each element shown in the schema file is saved as a layout file. The data processing equipment creates the XSLT file from the corresponding relation between the element of such schema file and the element of the layout file, and, in addition, creates the definition file explained in the base technology.

The user can change the display position of the element by drag and drop in the edit screen of the layout file. If the editing is performed after the definition file is created, the data processing equipment must reflect in the definition file the change in the correspondence relation between the element of the schema file and the display position of the layout file. The data processing apparatus monitors the correspondence relation between the sample value in the layout file and the element of the schema file. Therefore, even if the position of the element in the layout file is changed, the definition file can be updated according to the position of the sample value. Each display element included in the layout file is identified by the sample value. Therefore, the correspondence relation is redefined, using the sample value in the layout file as a key when the XSLT file is created.

FIG. 17 is a screen view when the destination file based on the edit result in FIG. 16 is displayed.

The destination file is created from the source file in accordance with the definition file. FIG. 16 is a screen displaying this destination file. Since there are three elements “customer” of the source file, three “customer” elements are displayed in accordance with the table format of FIG. 16. The user can edit the data of the source file via the screen in FIG. 17. This is the mechanism explained in the base technology as a vocabulary connection.

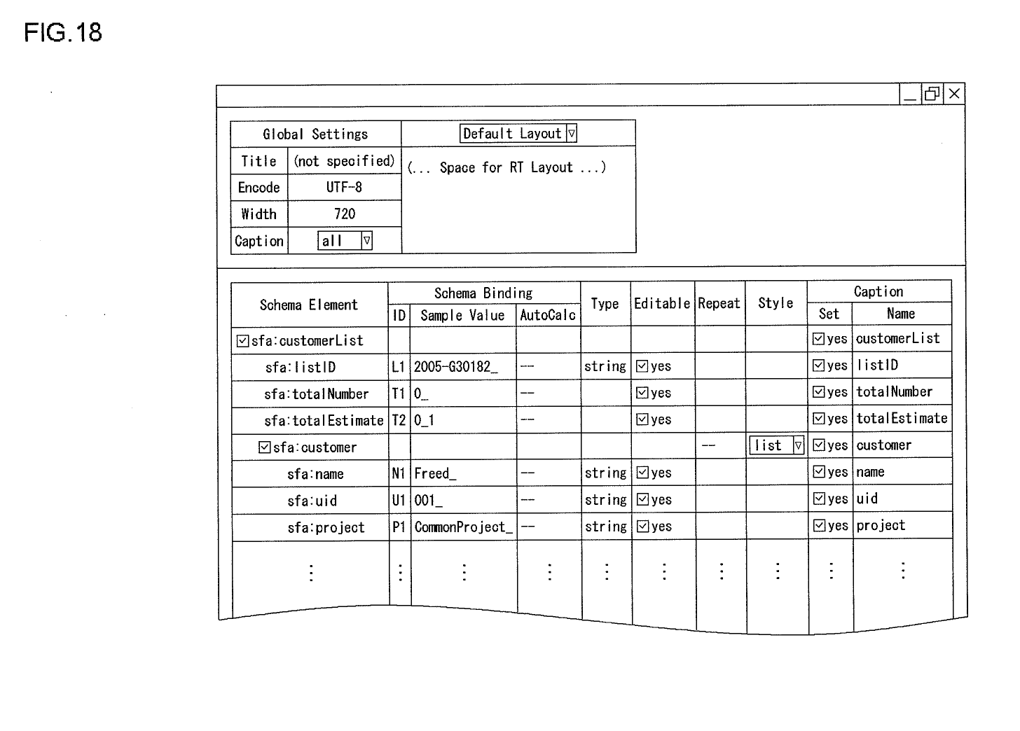

FIG. 18 is a diagram which shows another example of an editing screen for a binding file.

In the middle row of the property area in FIG. 18, the difference from FIG. 15 lies in that the display format is assigned so that the element “customer” is displayed in list format.

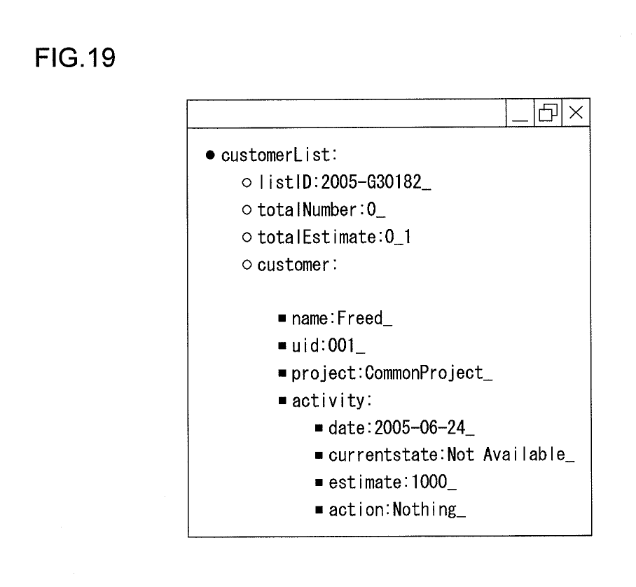

FIG. 19 is a diagram which shows an editing screen for a layout file based on the editing result of the binding file in FIG. 18.

The child element of the element “customer” is displayed in list format according to the assignment of the display format in FIG. 18. Thus, the layout file is changed in accordance with the assignment of the display format in the binding file.

In FIG. 18, the element “customerList/customer/name” of the schema file corresponds to the first element of each list shown in the layout file. The data processing apparatus creates the definition file explained in the base technology regarding the correspondence relation between such element of the schema file and the element of the layout file.

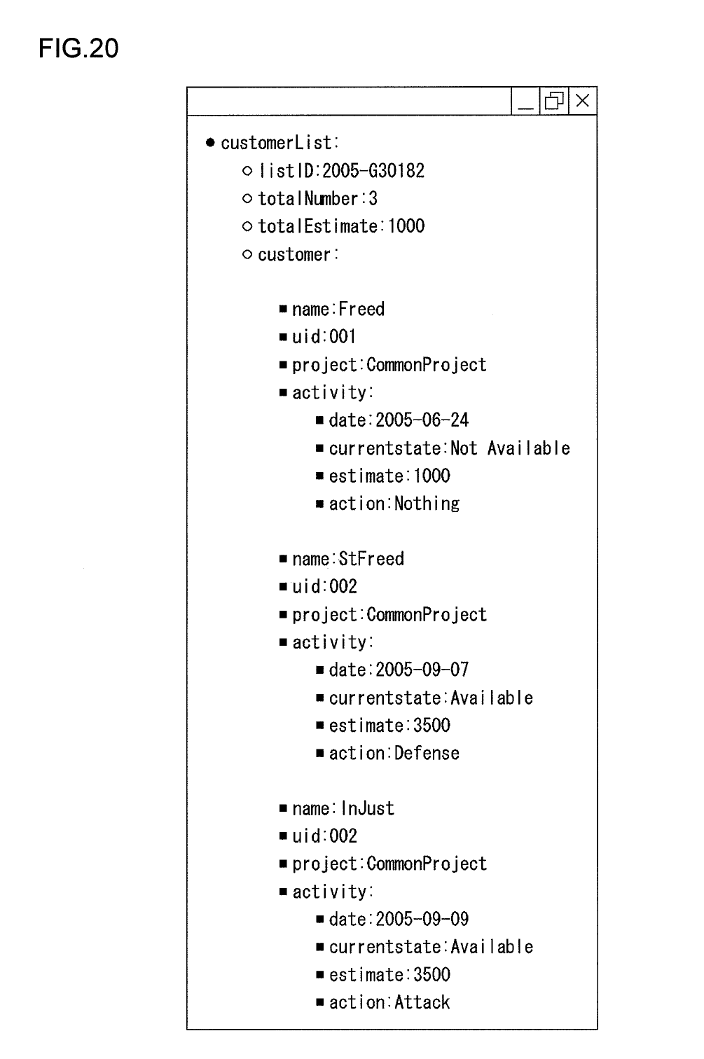

FIG. 20 is a screen view when the destination file based on the edit result in FIG. 19 is displayed.

Since there are three elements “customer” of the source file, the contents of the three “customer” elements are displayed in list in accordance with the list format of FIG. 18. The user can edit the data of the source file via the screen in FIG. 20.

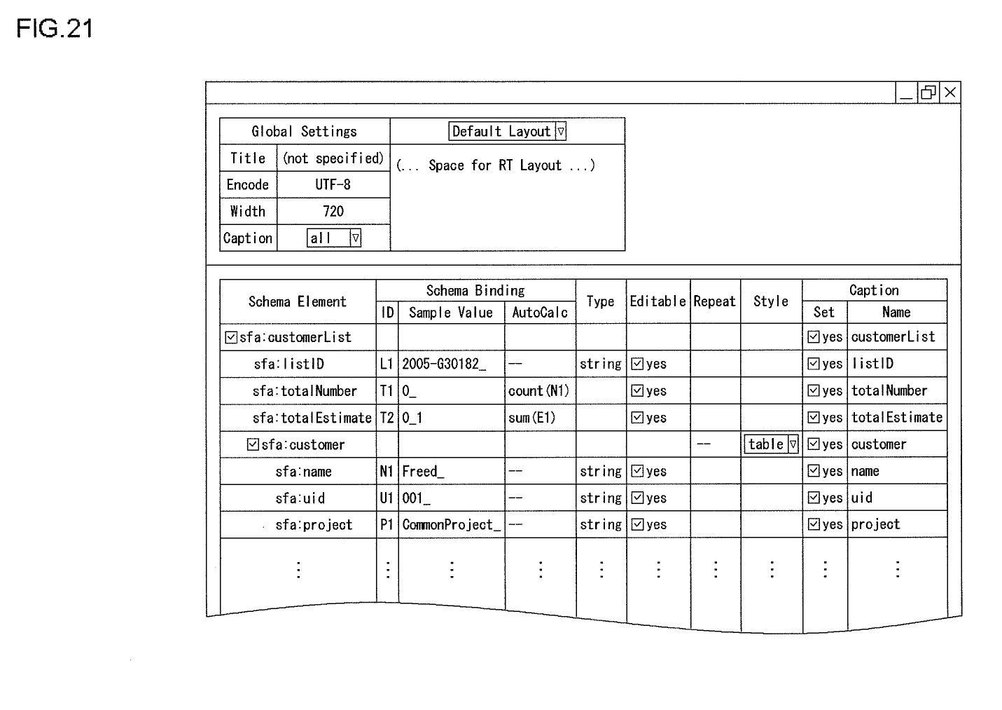

FIG. 21 is a diagram which shows another example of an editing screen for a binding file.

In FIG. 40, “count (N1)” is set by the editing manipulation of the user as the calculation formula to calculate the value of the element “totalNumber”. Since “N1” is the ID of the element “name”, the value of the element “totalNumber” is the number of the element “name” in the source file. Also, “sum (E1)” is set as the calculation formula to calculate the value of the element “totalEstimate”. Since “E1” is the ID of the element “estimate”, the value of the element “totalEstimate” is the total value of the value of the element “estimate” in the source file. Thus, each element can be handled in simple input format in the edit screen of the binding file, using not long element names, but the ID value.

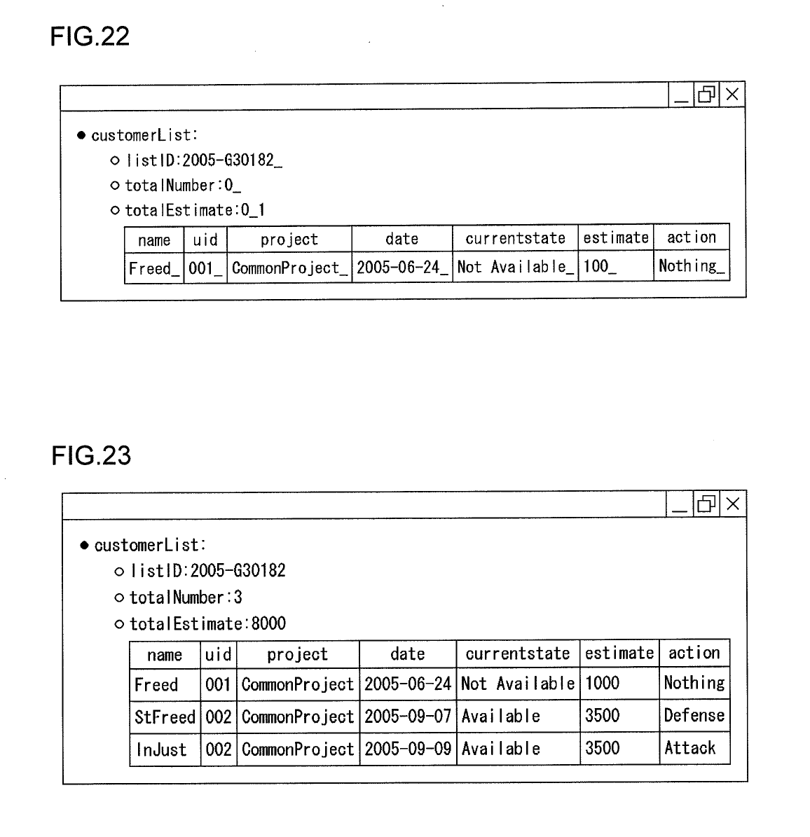

FIG. 22 is a diagram which shows an editing screen for a layout file based on the editing result of the binding file in FIG. 21. There is no difference in FIG. 22 and FIG. 16.

FIG. 23 is a screen view when the destination file based on the edit result in FIG. 22 is displayed.

In the item “totalNumber”, “3”, in other words, the number of the element “name” in the source file is displayed. Similarly, in the item “totalEstimate”, “8000” (i.e., the total value (1000+3500+3500=8000) of the element “estimate” in the source file) is displayed.

FIG. 24 is a diagram which shows another example of an editing screen for a binding file.

A description will now be given, using another schema file different from the schema file shown in FIG. 12 as an example.

As shown in FIG. 43, the user can set the basic layout in the layout file by arranging the ID in the layout area. When the binding file is displayed, the ID of each element is arranged in the layout area by default. The arrangement in this case may be the arrangement to which the element structure in the schema file is reflected. For example, the elements in the parent-child or the sibling relation may be arranged so that the display position become close to one another. Also, when the element names are similar as in “totalNumber”, “Number”, and “subtotalNumber”, these elements may be arranged so that the display position become close to one another. As described above, compared to the cases that require the initialization of the arrangement of the ID and the creation of the arrangement from scratch, the laborsaving of the creation of the layout can be enhanced.

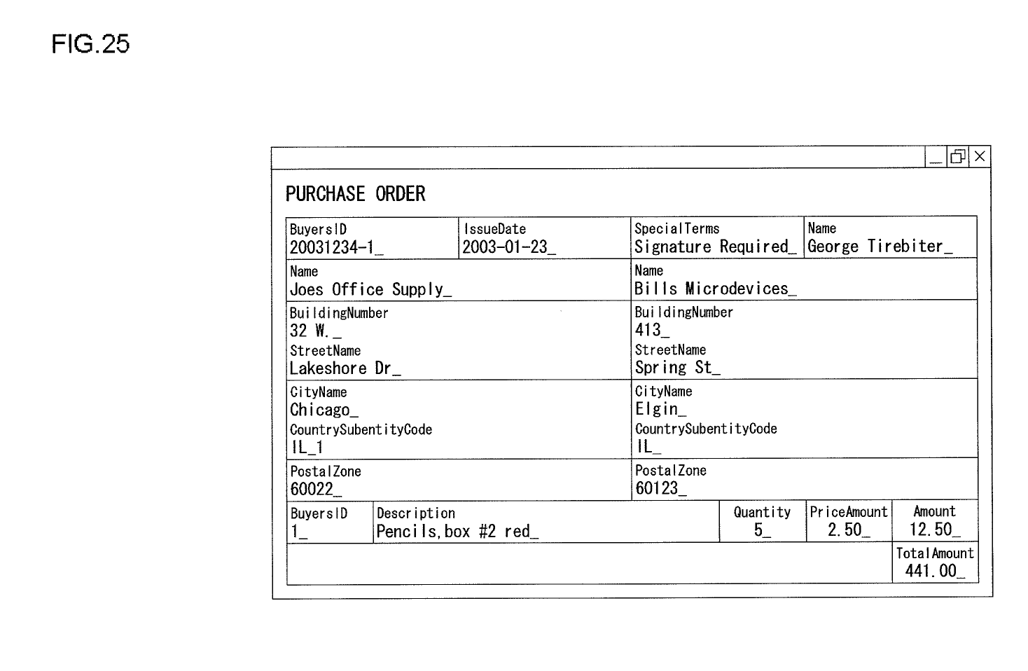

FIG. 25 is a diagram which shows an editing screen for a layout file based on the editing result of the binding file in FIG. 24.

In the layout file, each element is displayed in accordance with the editing contents in the layout area in FIG. 24.

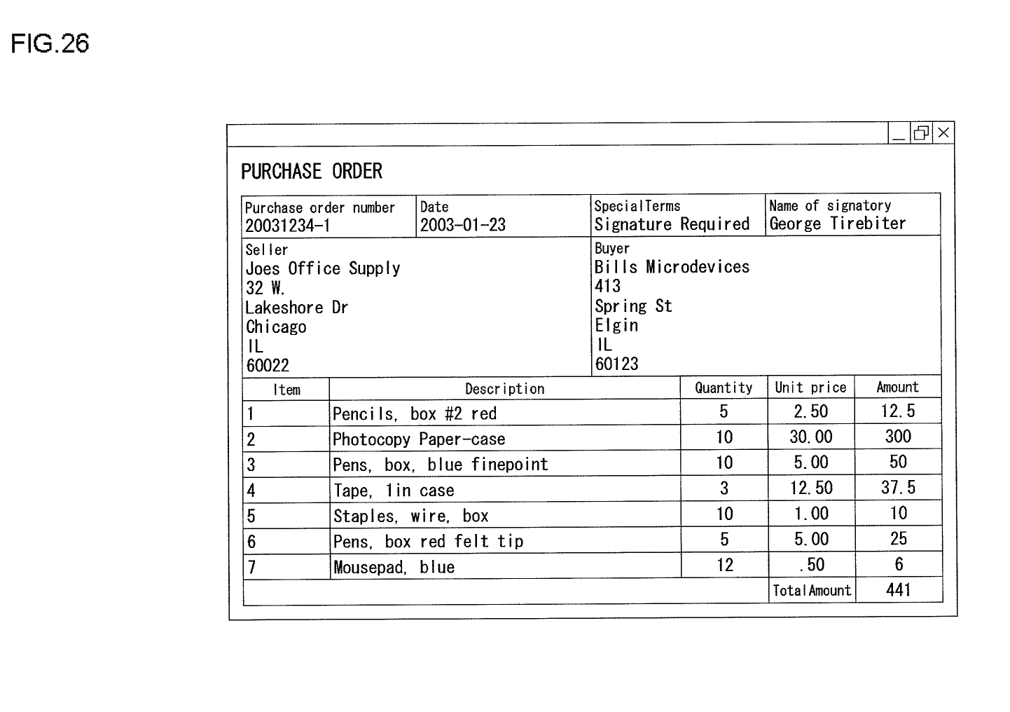

FIG. 26 is a screen view when the destination file based on the edit result in FIG. 25 is displayed.

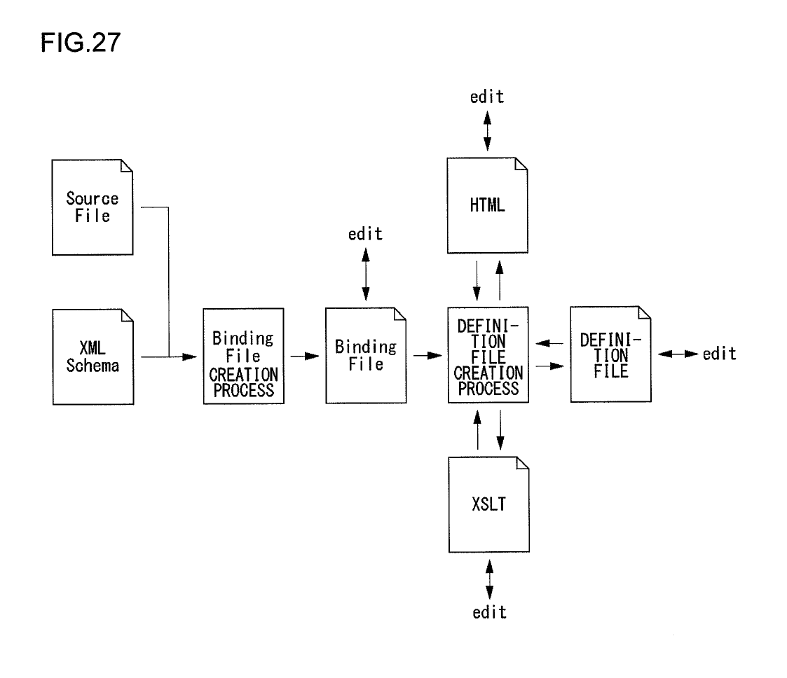

FIG. 27 is a schematic diagram which further illustrates a process of creating a definition file.

In addition, the supplementary information is added to the binding file by the editing manipulation of the user on the binding file in FIG. 27. The supplementary information is, for example, the definition or the redefinition of the rules on the element. The definition file is created based on this binding file; however, the XSLT file may be created instead of the definition file. In addition, the object to achieve the data mapping between the source file and the destination file, for example, the object of Java (registered trademark), may be created.

### Embodiment

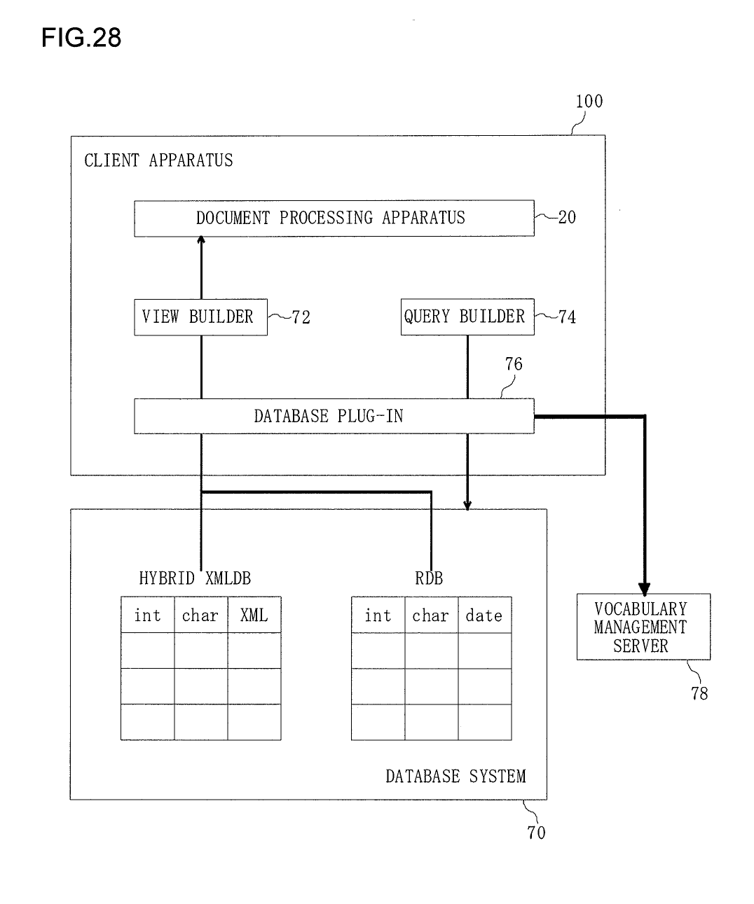

FIG. 28 shows the configuration of a data processing system according to the embodiment. In the embodiment, an integrated system of the document processing apparatus 20 explained in the base technology and the database system 70 according to the embodiment will be explained as being an environment where an application that satisfies the advanced informatization demand can be easily developed by combining with complete control the information partitioned by a standardized XML schema and valuable data resources accumulated for a long period of time in a company. Also, a description will be given regarding that prompt and high-quality decision-making in business is achieved by the environment and that also in a personal computing environment in a network environment, a new infrastructure that can provide optimal services to meet the needs is developed.

From a perspective of the standardization and partitioning of information by XML, the document processing apparatus 20 is designed to be able to create an application by combining XML vocabularies in various formats as XML objects freely without limitation. As if painting on a canvas with complete control combining colors freely on a palette, the highly integrated application with desired information combined can be obtained.

In such an environment, a strong ability is also required in a system that stores information. In addition to the high demand for computing the information in XML format, there is an increased demand for transparently handling data resources stored previously in RDB and handling various data in a compounding manner. The database system 70 in the embodiment has a hybrid structure in which the RDB resources and XMLDB resources stored in the system can be accessed freely through both SQL and X-Query and can be input and output as data in either format.

While the conventional enterprise information system is developed with a backbone system at the center and the focus has been on a style where a result of processing is provided, an enterprise application using the document processing apparatus 20 achieves the integration of information and the integration of applications. A system can be achieved where users of the application can purposefully process the information, make decisions, and lead the business to succeed.

It is not necessary to program directly in SQL or

X-Query for an inquiry to the database. The query builder supports the inquiry to the database with GUI. Also, since a vocabulary dictionary in a vocabulary management server is linked, the XML data with overflowing XML schema and XML data with a different XML schema can be utilized reasonably.

Even with an ability provided by the system to process data freely, a mechanism to express it as a simple and effective GUI is still required. A view builder analyzes a query result and builds data for displaying semi-automatically the query result.

The difference between the conventional system development and the system development by the document processing apparatus 20 in the embodiment lies not only in a system architecture and a development procedure but also in that an optimal resolution is provided to the theme of whether IT can properly keep up with the critical change in the business. The system achieved by the document processing apparatus 20 enables the integration of the information in a client without imposing a structural change of a server against a dynamic change of a business structure. Moreover, in combination with web services, a rich user-oriented application can be provided speedily.

In order to prevent the increase in the development man-hour caused by the change in the database schema, the conventional construction of an information system having RDB as a base is completed in the following order: designing the database schema after a small-scale prototyping, developing a middleware, and developing a GUI. Despite the advanced design environment and development tools, the order has not changed even today. In the conventional method, even though the risk for modification is reduced by confirming the task in each phase, it is difficult to shorten the whole process.

In the system development using the document processing apparatus 20 and the database system 70, the focus is on the program development where the structural information that the XML data has is used without constructing a fixed schema in DB. With this, the developer can develop a processing program while evolving the information structure at the same time. It is shown that this method can not only shorten the development process in the initial stage of the development but also respond flexibly to the various demands for a change after the completion of the development.

Since the method of development where a plurality of XML schemas can be combined freely without any restriction is taken in the document processing apparatus 20, the efforts to improve the system can be made repeatedly in a short period by adding expansions necessary for the user while using already established XML schema with high practicability. Accordingly, not only the development can be completed in a short period with a very little man-hour but also the really practical system to match the needs can be provided because of the repeated improvements.

Every intra-firm data resource protected securely by the database system 70 can be handled flexibly by the client. Thus, the structure and maintenance of the system become very simple.

Combined dynamically in the document processing apparatus 20 in accordance with the request from the user, the withdrawn information can be transformed multi-purposely with complete control into an information asset that is optimal for services.

The document processing apparatus 20 is an XML handling environment having a simple and powerful mechanism to seamlessly compound multiple XML vocabularies. The document processing apparatus 20 has a function of utilizing various XML information stored in the database system 70 and integrating XML service information items from different internet and intranet sources.

The database system 70 is a hybrid XMLDB. The database system 70 expands a field type to include an “XML” field type in addition to the conventional field type of a relational database and defines these types while containing in one table so that the types can be handled in the same transaction. Also, the database system 70 has a conversion function of reading a conventional RDB table in XML format.

A vocabulary management server 78 is a server process for managing and sharing the semantic relationship between XML tags. The tags of different XML vocabularies can also be managed. The vocabulary management server 78 retains the correspondence relation of the data of the same type of tags from the XML tags appended to the XML data stored in the database system 70. For example, the correspondence relation is retained which indicates that, for example, the attribute “name” of the element “student” of the marks managing vocabulary shown in FIG. 2 and a tag “name” of another vocabulary are the XML tags storing “names”. As will hereinafter be described in detail, the correspondence relation is used in the GUI provided by the query builder 74.

The query builder 74 is a standard GUI for generating query statements for XMLDB and RDB in an interactive manner. The query builder 74 acquires and presents the information retained in the database system 70 indicating the structure of the data structured in a markup language, receives the specification of the data from the data presented to be embedded into the document, and generates a query statement for the received data. At the same time, the query builder 74 acquires the correspondence relation between XML tags from the vocabulary management server 78 and presents the correspondence relation identifiably when presenting the structure of XML data retained in the database system 70. With this, even when the user does not grasp the meaning of the tags in advance, the user can see the semantic relationship of the tags on the GUI provided by the query builder 74. Thus, in conjunction with the vocabulary management server 78, the GUI can be provided in which an end-user can obtain information without checking various XML schemas in XMLDB in advance. With this, the XML data with different schemas can be managed and applied properly without undue difficulty.

A view builder 72 analyzes search results received from the database system 70 and automatically creates a view to display. As described in the base technology, the view builder 72 may create the view to display by creating a definition file automatically for displaying the XML data acquired from the database system 70. The structure of the query result of XML database can be changed in accordance with the query content. This indicates that in a system where only a fixed schema can be used, the ability of the XML database cannot be fully utilized. On the other hand, in the document processing apparatus 20 in the embodiment, since a view can be created automatically for an arbitrary schema, the data can be displayed in an appropriate manner even in the case the schema changes fluidly. The query builder 74 can generate a query statement for acquiring the data of the conventional field type retained in the database system 70, that is, the data not structured in the markup language, in the format of the data structured in the markup language. Accordingly, the document processing apparatus 20 can acquire the arbitrary data stored in the hybrid database system 70 in XML format in accordance with the arbitrary schema and create a view automatically.

Query conditions and query results for the database system 70 are connected to the database system 70 by the database plug-in 76. The differences in a lower database system are absorbed by this middleware, and the capability of an upper application is ensured.

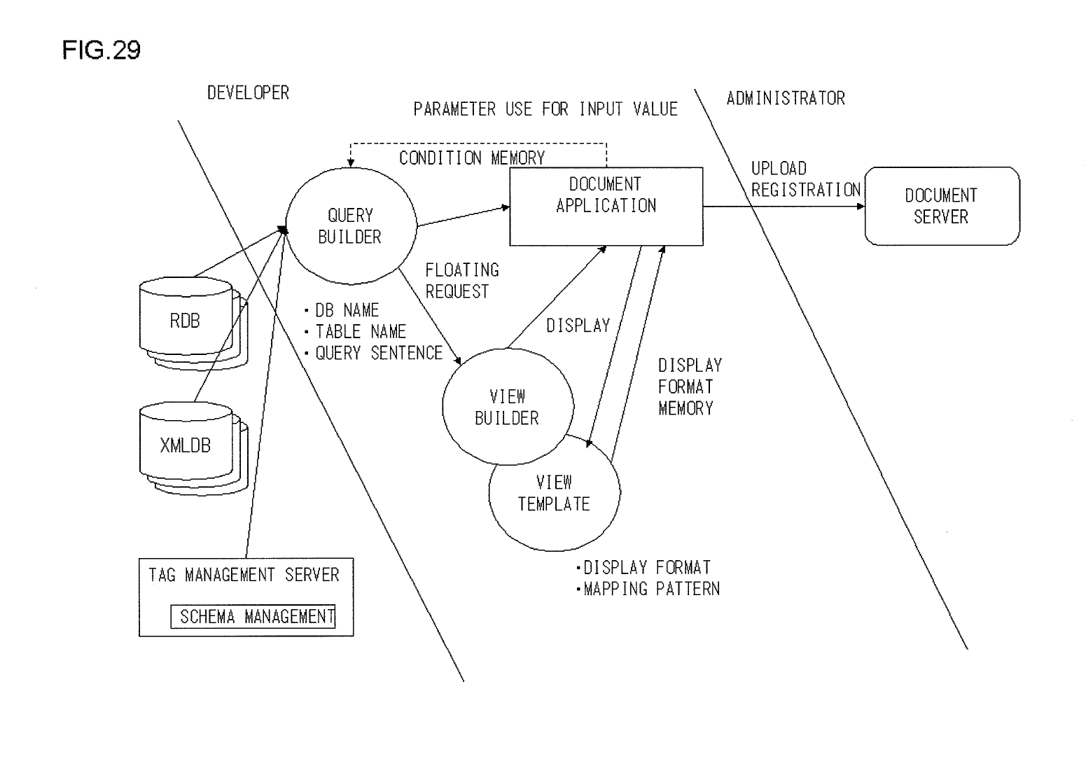

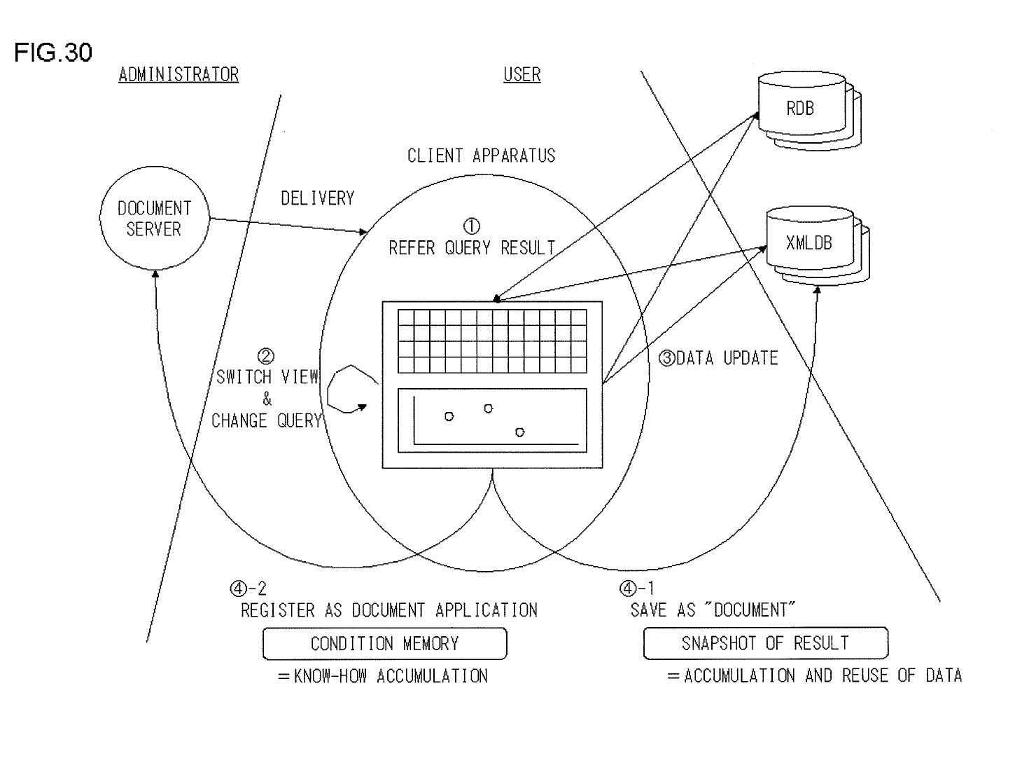

FIG. 29 shows the creation process of a XMLDB integrated document application. The XMLDB integrated document application can be created by the document processing apparatus 20. In modeling a form of a desired application while using a vocabulary component (e.g., HTML unit and SVG unit) and a view template in the document processing apparatus 20, an application in which data sources accumulated in DB can be utilized can be constructed by attaching to the application a condition-memory type vocabulary component that can be connected to XMLDB/RDB.

The method (know-how) to extract a data source accumulated in a legacy system in accordance with a purpose can be specified by using GUI provided by the query builder 74 without being aware of the differences in DB systems including the differences in RDB/XMLDB.

Also, a conditional expression created is stored as a parameter value of the condition-memory type vocabulary component attached to the application.

A tag management function can be used as a mechanism to handle information in more object-oriented manner. With this, a conditional statement focusing on the original meaning of the information that is managed with a tag can be generated without taking the differences in tag names into consideration for every schema. Also, sharing the definition of such tag management within a company allows an application designer to easily design conditions with little lack of consideration.

The schema in the query results obtained as a result of the DB access can be changed dynamically according to the query statement and search result of a caller. The view builder 72 is prepared as a function to automatically visualize these output results.

Also, a view template can be used as a function, which is specific to the services and purposes, to provide more suitable expressions. This allows the display of the extracted data in a map format using a “creation data” and a “creator” as keys. This method of expressing the query results is also stored in the XML application.

The XML application developed as described above is registered in a document server and can be downloaded and used by the user whenever he/she is in need.

FIG. 30 shows the process of using an XMLDB integrated document application. A client user starts the document processing apparatus 20 of a client apparatus and selects an XML application in accordance with the services from a list of XML applications.

Once the XML application is started, the RDB/XMLDB is accessed using the conditional expression stored in the vocabulary component. If the expression format is specified in the latest query result in advance, the specified expression is used to display the query result, and if the expression format is not specified, the query result is automatically visualized by the view builder 72 and displayed in the XML application.

The display of the query result can be saved in a document as a snapshot at the moment. The saved document is an XML document, and the accumulation of the documents in XMLDB achieves a cycle of “building data by reusing the existing data”.

The conditional expressions and methods of expressing the query results that are stored as document applications can also be changed freely by the users. Registering the changed conditional expressions and methods of expressing the query results again as XML applications in the document server, not only the periods for developing business applications of the same type can be shortened but also the business applications can be developed in which the users' purposes are reflected from bottom up.

The system addressing a dynamic change in a business structure implemented by the document processing apparatus 20 and the database system 70 enables not only the integration of the information in a client but also the speedy provision of a rich user-oriented application. The environment can also be provided where users in a company utilize the information asset within the company and the collaboration to enhance competitiveness can be achieved. The infrastructure to optimally use the data resources in a company promotes a step toward an era of a XML application that provides an infrastructure where a user optimally uses an information asset and an application asset.

Described above is an explanation based on the embodiments of the present invention. These embodiments are intended to be illustrative only and it will be obvious to those skilled in the art that various modifications to constituting elements and processes could be developed and that such modifications are also within the scope of the present invention.

### INDUSTRIAL APPLICABILITY

The present invention can be used for a document processing apparatus for processing a document structured.

1. A document processing apparatus operative to process a document structured in a markup language comprising:
a query builder operative, when data retained in a database system is embedded in the document, to generate a query statement which corresponds to the database system; and
a view builder operative, when a result of the query statement is acquired from the database system in a format of data structured in the markup language, to generate a screen which displays the result.

2. The document processing apparatus according to claim 1, wherein the query builder acquires and presents information that indicates a structure of data structured in a markup language retained in the database system, receives a specification of data to be embedded into the document from among the data presented, and generates a query statement for the received data.

3. The document processing apparatus according to claim 1, wherein the query builder acquires a correspondence relation of data of the same type among the data structured in the markup language from a management server retaining the correspondence relation, and presents the correspondence relation identifiably when presenting the structure of the data structured in the markup language.

4. The document processing apparatus according to claim 1, wherein the query builder can generate a query statement for acquiring in the format of the data structured in the markup language the data not structured in the markup language retained in the database system.

5. A data processing system comprising:
a document processing apparatus operative to process a document structured in a markup language; and
a database system operative to retain data available for the document, wherein
the document processing apparatus comprises:
a query builder operative, when data retained in the database system is embedded in the document, to generate a query statement which corresponds to the database system; and
a view builder operative, when a result of the query statement is acquired from the database system in a format of data structured in the markup language, to generate a view which displays the result.

6. The data processing system according to claim 5, further comprising a management server for managing a correspondence relation between the data retained in the database system.

7. The data processing system according to claim 5, wherein the database system is a complex database system with a XML database and a relational database.

8. A document processing method comprising:
generating, when a document processing apparatus that processes a document structured in a markup language embeds in the document data retained in a database system, a query statement corresponding to the database system; and
generating, when a result of the query statement is acquired in a format of data structured in the markup language from the database system, a screen for displaying the result.

9. A computer program product comprising:
a module that generates, when a document processing apparatus that processes a document structured in a markup language embeds in the document data retained in a database system, a query statement corresponding to the database system; and
a module that generates, when a result of the query statement is acquired in a format of data structured in the markup language from the database system, a screen for displaying the result.
